(19) United States
(12) Patent Application Publication
(10) Pub. No.: US 2009/0110886 A1
(43) Pub. Date: Apr. 30, 2009

(54) Tanning Implement

(76) Inventors: Keith Brink, Oklahoma City, OK (US); Rebecca Kaye Brink, Oklahoma City, OK (US)

Correspondence Address: HARVEY CONSULTING PLLC, PO BOX 6568, NIRMAN, OK, 73072, US

(21) Appl. No.: 11/927,612

(22) Filed: Oct. 29, 2007

(51) Int. Cl. B32B 3/26

(52) U.S. Cl. 428/174

(57) ABSTRACT

The present invention relates to training in the field of beauty and tanning services. More specifically, the invention relates to an apparatus that eliminates unwanted tan lines left on the body during tanning sessions. Even more specifically, the invention relates to an ultraviolet transmitting implement that separates folds of skin so that a patron of tanning services may receive a more complete tan and eliminate tanning lines.

### BACKGROUND OF THE INVENTION

The present invention relates to instruction and training in the field of beauty and tanning services. More specifically, the invention relates to an apparatus that eliminates unwanted tan lines left on the body during tanning sessions. Even more specifically, the invention relates to an ultraviolet transmitting apparatus that separates folds of skin so that a tanner's body may receive a full body tan.

In the beauty care industry, business owners provide tanning services to those seeking to enhance the color tone of their skin. Conventionally, those tanning services consist of receiving artificial light from ultraviolet emitting bulbs in a tanning bed to simulate and achieve a skin color and tone from the sun, or from natural light.

Tanning equipment using artificial light emitters comprises at a minimum a tanning bed and light bulbs, whereas the tanner's body is placed horizontally in the bed and receives artificial light emitted from the light bulbs directed upon the exposed surfaces of the body. Therefore, it is accepted in the industry of tanning services utilizing artificial light that only the surfaces of the body exposed to the light emanating from the light bulbs will benefit from the tanning service. However, it is difficult to ensure that the tanner's body uniformly and completely receives the benefit of the bed's light bulbs. Often, the body's natural folds and crevices will shield parts of the body from the desired tanning light bulbs, resulting an uneven tan and areas of pale skin that detract from the objective of receiving a full tan.

Thus, it can be seen in the industry of tanning services that there is a continued need for patrons of tanning services to receive the benefit of a full complete tan. It can further be seen that an approach is needed that will allow the patrons of tanning services to tan areas of the body that are naturally shielded from the sun and a tanning bed.

### SUMMARY OF THE INVENTION

The present invention achieves its intended purposes, objects, and advantages through a new, useful, and unobvious combination of component elements, with the use of a minimum number of functioning parts, at a reasonable cost to manufacture, and by employing only readily available materials. In these respects, the present version of the invention substantially departs from the conventional concepts and designs of the prior art, and in so doing provides an apparatus that substantially fulfills this need. Additionally, the prior patents and commercial techniques do not suggest the present inventive combination of component elements arranged and configured as disclosed herein.

These and other features, aspects and advantages of the present invention will become better understood with reference to the following drawings, description and claims. For a better understanding of the invention, its operating advantages and the specific objects attained by its uses, reference should be made to the accompanying drawings and descriptive matter in which there are illustrated preferred embodiments of the invention. The foregoing has outlined some of the more pertinent aspects of the invention. These aspects should be construed to be merely illustrative of some of the more prominent features and applications of the present invention. Many other beneficial results can be attained by applying the disclosed invention in a different manner or by modifying the invention within the scope of the disclosure. Accordingly, other aspects and objects may be discerned from a fuller understanding of the invention and the detailed description of the preferred embodiments in addition to the scope of the invention illustrated by the accompanying drawings.

The present invention may comprise a tanning implement having certain ultraviolet transmitting properties. The present invention may further comprise a structural configuration that facilitates placement proximal to and distributing of folds of a human body. The invention may even further comprise an implement that eliminates unwanted tan lines created during tanning. The invention may also include the tanning implement including engaging surfaces comprising rounded or convex aspects for ease of interface of the implement with tanning beds and patrons thereof.

In an embodiment of the present invention, a portable implement for a patron of tanning bed services is disclosed comprising an ultraviolet transmitting portion of material such as acrylic, whereby the portion may separate folds of skin of the human body, a first surface and a second surface, a first engaging portion of the first surface, a second engaging portion of the second surface, the first and second engaging portion engaging a tanning bed upon which the patron may rest, a midsection disposed between the first and second surface, the midsection substantially separating folds of skin of the patron receiving tanning bed services, the first engaging portion including first engaging portion ends and a midpoint, the second engaging portion including second engaging portion ends and a midpoint, whereby the midpoint slopes upwards to the first and second engaging portion ends and the midsection is convex.

In another embodiment of the present invention, An implement for a patron of tanning bed services is disclosed comprising an ultraviolet transmitting material comprising convex and concave surfaces, the implement separating folds of skin.

In another embodiment of the present invention, a method for producing a full, complete tan for patrons of tanning beds is disclosed. The method may comprise positioning a ultraviolet-transmitting article between the folds of the human body, securing the head retaining system to the back of a chair and simulating the application of beauty or oral hygiene services to the head of a human by rotating the mannequin head in appropriate planes of axis of the human head.

### BRIEF DESCRIPTION OF THE DRAWINGS

FIG. 1 is a frontal view of a engaging surface of tanning implement, according to preferred embodiments of the current invention.

FIG. 2 is a side axial perspective view of the tanning implement, according to preferred embodiments of the current invention.

FIG. 3 is a top view of the tanning implement, according to preferred embodiments of the current invention.

FIG. 4 is a side perspective view of the tanning implement in use, according to preferred embodiments of the system.

FIG. 4 is a side perspective view of the tanning implement in use, according to preferred embodiments of the system.

### DETAILED DESCRIPTION OF THE INVENTION

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims.

Enthusiasts of tanning services have long sought out solutions to attaining a natural looking, complete body tan. The most popular service for receiving artificial tanning application remains the tanning bed. Patrons of the tanning bed generally lay in a tanning booth that generates and emits ultraviolet light in such a way that, ideally, the skin of a patron's body absorbs the ultraviolet light and subsequently tans in a consistent manner. The patron may wear swim wear but often fully disrobes in order to eliminate tan lines formed by shielding certain parts of the body from the ultraviolet light.

Even when fully disrobing, however, the patron does not completely eliminate tan lines. Tan lines are created not just by wearing swim wear. The natural folds of the human body also create tanning lines. For example, regions of a patron's body such as under the buttocks, arms and breasts may naturally fold during artificial tanning application, creating a gradual lightening to stark paleness in those regions that naturally fold. When the patron display his or her tan in public, those regions that naturally fold and do not receive the ultraviolet light often reveal themselves and their paleness to the dismay of the patron and the detriment of the tanning service rendered. Thus, there remains an ongoing need to shed light upon the darkness that remains in those regions that naturally fold of patrons of tanning services.

The present invention effectively addresses such needs associated with the patrons of artificial tanning applications. In contrast to previous attempts to provide the patrons with a full complete tan by improving the lights in the tanning beds, the present invention provides a tool for separating the natural folds of skin of the patron's body and transmitting the ultraviolet light to regions otherwise. The advantages of this over other approaches in the art are many. The present invention uses a makeup and configuration not known in the present art, structured to effectively and comfortably separate natural folds in the patron's body. The inventive tool may take shape and structure in a number of ways that accomplish the objective of separating the natural folds of the body. No prior art reference foresees a solution that accomplishes the objective of separating the natural folds of the body in such a simple manner. The inventive tanning implement may be mobile and transferable to different regions of interest during the same session of artificial light application to the body, allowing the patron to use his or her own tool wherever the patron opts to receive such tanning services without having to share such a personal accessory. By providing such a tanning implement that separates the natural folds of the body, the present invention accomplishes what the disclosed art attempted to solve unsuccessfully. The invention improves upon solutions in the art that invariably attempt to position the patron vertically or attempt to teach the patron how to hold his or her body to reveal the regions within the natural folds of the body.

As has been demonstrated, the present invention provides an advantageous accessory to tanning services that allow a patron of tanning beds to receive a complete tan and eliminate tan lines. While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

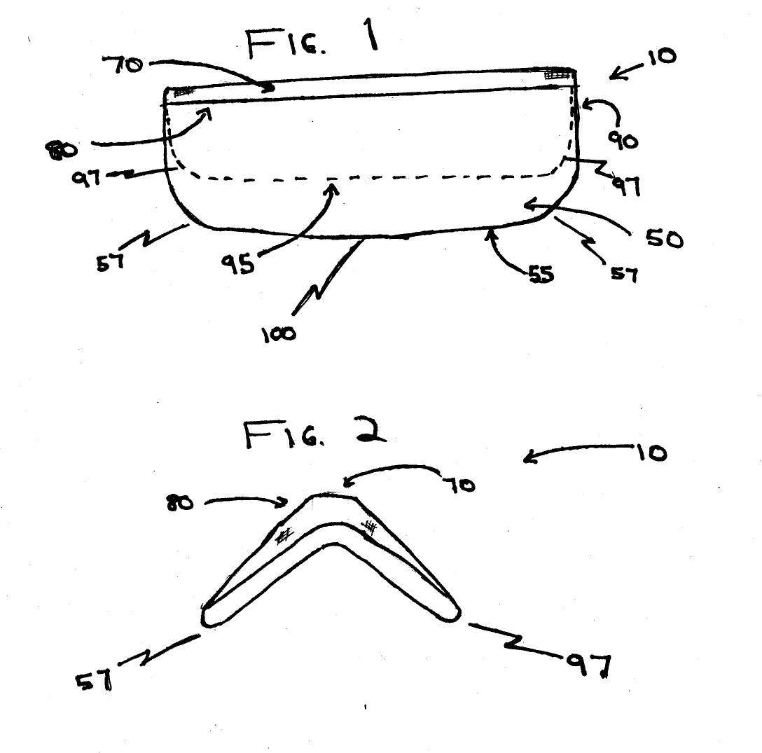

Looking at FIG. 1, an embodiment of the invention is seen as the tanning implement 10 for use with patrons of tanning services. Tanning implement 10 may comprise a number of surfaces and may allow the passage of ultraviolet rays. Materials such as acrylics and others that substantially allow the passage of ultraviolet rays may be utilized. In one embodiment of the invention, tanning implement may comprise surfaces 50 and 90. Surfaces 50 and 90 may adjoin at a midsection 70 to form a segue 80 between the surfaces 50 and 90. Midsection 70 may provide separation of natural folds of skin commonly obscured when a patron rests in, for example, a horizontally-disposed tanning bed. Midsection 70 may reach or approximate the innermost portions of the natural folds of skin that inhibit even tanning. Areas of concern for patrons of tanning services include under the breast, buttocks, chin, any other location on the human body where skin may naturally crease or naturally fold, resulting in an area where the ultraviolet rays do not reach and skin remains pale. In other embodiments not shown, the implement 10 may comprise any number of surfaces or shapes that serve to separate natural folds of skin for the passage of ultraviolet light. For instance, the implement may comprise more evenly rounded or convex surfaces than those disclosed in FIGS. 1-4, such as a cylinder with its rounded surface interfacing with the tanning bed and the tanning patrons. The implement may have an upward U-shape lifts and separates folds. The implement may have a number of configurations that achieve the end result of separating folds of skin with ultraviolet material.

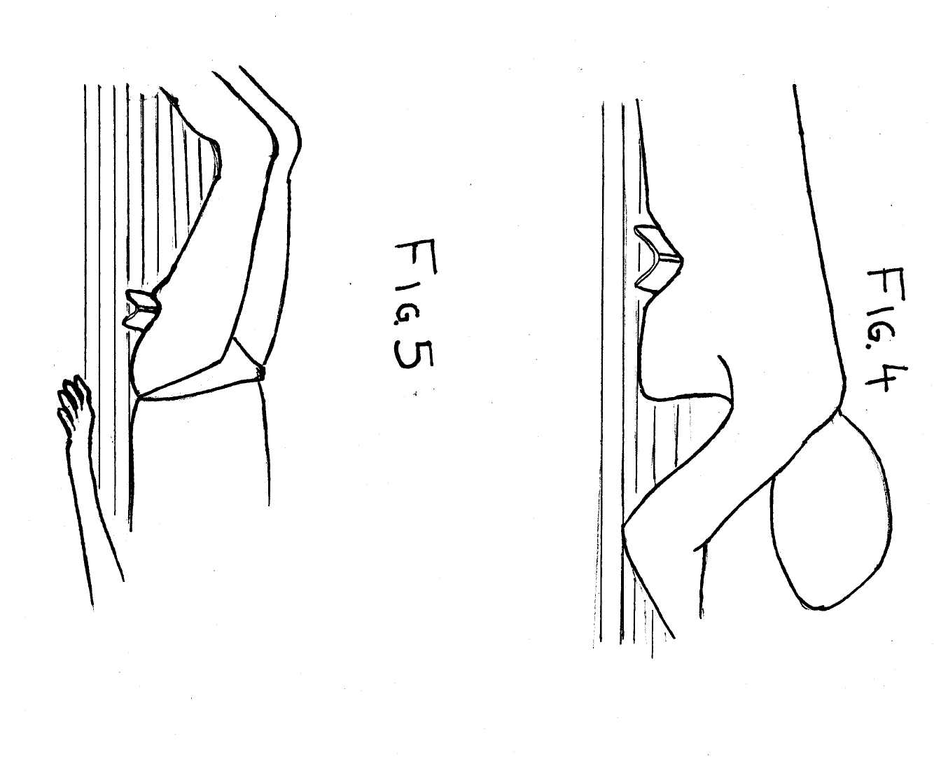

Surfaces 50 and 90 may, according to FIGS. 1 and 2, comprise engaging portions 55 and 95, respectively. Engaging portions 55 and 95 may serve to directly engage the tanning bed in a manner that does not cause harm to the surfaces of tanning beds. In another embodiment of the invention, portions 55 and 95 may comprise, at the engaging portion ends 57 and 97, a gentle slope 70 away from a midpoint 100 of engaging portions 57 and 97, the surface of the tanning bed that allows the portions 55 and 95 to roll towards the end 57 or, alternatively towards the end 97. It is also within the scope of this invention that portions 55 and 95 do not need to directly engage the tanning bed.

Midsection 70 may be disposed between surfaces 50 and 90, or in other embodiments of the invention not shown represent a convergence of other surfaces, the convergence those surfaces intended to engage the body of the patron of tanning services. In FIGS. 1 and 2, the midsection 70 is shown to have an exterior aspect 75 comprising a shape appropriate to separate folds of skin in a manner that does not irritate or cut into the skin of patron of tanning beds. Midsection 70 is shown in FIGS. 1 and 2 to have a width appropriate for finding comfortable purchase against the skin of the patron, yet narrow enough to fit into folds of skin without spreading separated skin into a new fold of skin distal of the implement 10. Given such a goal of the invention, it is understood that different sizes and proportions of implement 10 may be appropriate for different overall body sizes.

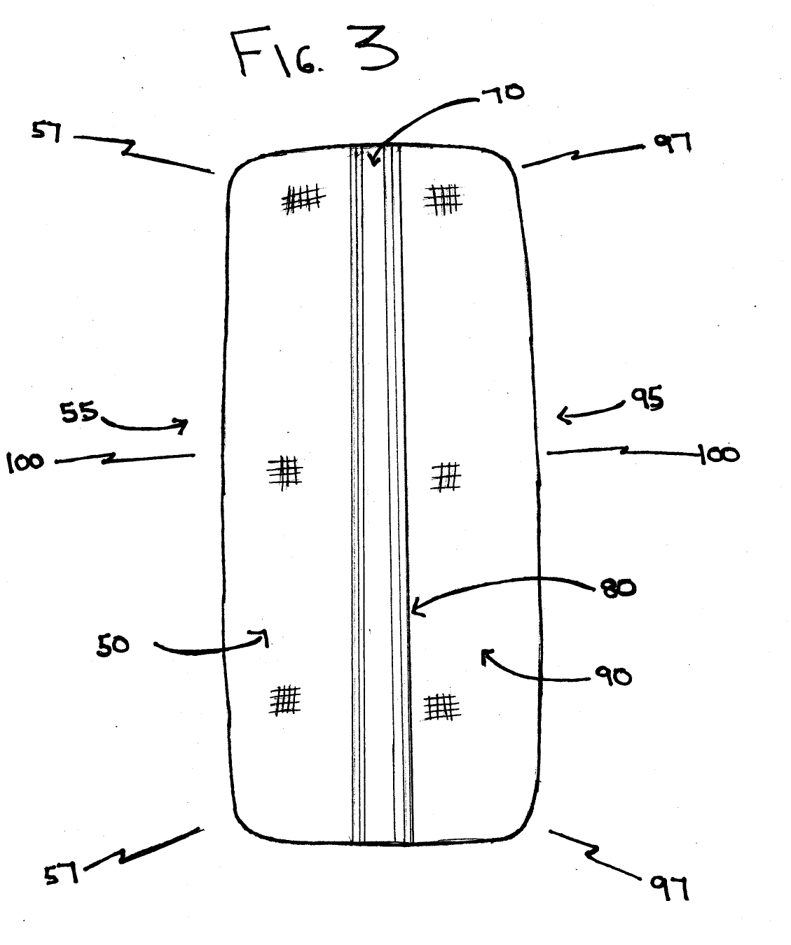

Looking to FIGS. 3 and 4, the inventive tanning implement is shown in use. Midsection 70 is positioned so that, within natural folds of skin such as underneath the breast or the buttock, it approximates the innermost portion of skin within the fold. As can be seen, tanning implement 10 may interact with a tanning bed in a manner that does not scratch or damage the tanning bed. Engaging portions 55 and 95 of implement 10, as seen in FIG. 1, along with engaging portion ends 57 and 97, may comprise such rounded surfaces as to allow the patron to shift or roll on a plane towards the ends 57 and 97.

It will be understood that the specification and examples are illustrative but not limitative of the present invention and other embodiments within the spirit and scope of the invention will suggest themselves to those skilled in the art.

We claim:

1. A portable implement for a patron of tanning bed services comprising:
an ultraviolet transmitting portion of material, whereby the implement may separate folds of skin of the human body.

2. The implement in claim 1, the portion further comprising
a first surface and a second surface,
a midsection disposed between the first and second surface, the midsection substantially separating folds of skin of the patron receiving tanning bed services.

3. The implement in claim 2 further comprising
a first engaging portion of the first surface,
a second engaging portion of the second surface, whereby the first and second engaging portion engaging a tanning bed upon which the patron may rest.

4. The implement in claim 3 further comprising
the first engaging portion including first engaging portion ends and a midpoint,
the second engaging portion including second engaging portion ends and a midpoint, whereby the midpoint slopes upwards to the first and second engaging portion ends.

5. The implement in claim 2, whereby the midsection is convex.

6. The implement of claim 1, whereby the implement further comprises an acrylic material.

7. A portable implement for a patron of tanning bed services comprising
an ultraviolet transmitting portion of material such as acrylic,
a first surface and a second surface,
a first engaging portion of the first surface,
a second engaging portion of the second surface, the first and second engaging portion engaging a tanning bed upon which the patron may rest,
convex midsection disposed between the first and second surface, the midsection substantially separating folds of skin of the patron receiving tanning bed services,
the first engaging portion including first engaging portion ends and a midpoint,
the second engaging portion including second engaging portion ends and a midpoint, the midpoint sloping upwards to the first and second engaging portion ends.

8. An implement for a patron of tanning bed services comprising;
An ultraviolet transmitting material comprising convex and concave surfaces, the implement separating folds of skin.
